(19) United States
(12) Patent Application Publication
(10) Pub. No.: US 2002/0019732 A1
(43) Pub. Date: Feb. 14, 2002

(54) Interactivity using voice commands

(76) Inventors: Dan Kikinis, Saratoga, CA (US); Yakov Kamen, Cupertino, CA (US); Gene Feroglia, Los Altos, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/875,461

(22) Filed: Jun. 5, 2001

Related U.S. Application Data
(60) Provisional application No. 60/218,098, filed on Jul. 13, 2000.
(60) Provisional application No. 60/218,022, filed on Jul. 12, 2000.
(60) Provisional application No. 60/218,015, filed on Jul. 12, 2000.
(60) Provisional application No. 60/215,581, filed on Jun. 30, 2000.

(51) Int. Cl. G10L 21/00

(52) U.S. Cl. 704/201

(57) ABSTRACT

A method and apparatus for controlling an interactive television system using voice commands. In one embodiment, a remote control device contains a microphone, into which a user may speak. Circuitry within the remote control device digitizes the speech. The speech may then either be processed by the remote control device or sent to a set top box (STB) for processing. The STB then performs the command given by the user.

### FIELD OF THE INVENTION

The invention related to the field of interactive programming. More specifically, the invention relates to providing a better interface for interactive programs.

### BACKGROUND OF THE INVENTION

An Electronic Programming Guide (EPG) displays information about programs a viewer is currently watching as well as information about other programs on different channels or at different times. The first EPGs were typically displayed on one channel of a cable television system. These early EPGs were simple, displaying short program descriptions and scrolling past the screen at a predetermined rate. Also, these EPGs typically did not allow for user interaction. More recent digital EPGs allow for the user to interact with the programming schedule, and to view programs while scanning the guide. However, digital EPGs still typically rely on the television as a means of showing the EPG.

Currently, EPGs are displayed only on the primary video display, typically a television, itself. This is because a television is usually the most expensive component in a home entertainment system, and further because until recently a television was the only display device in many homes. As a result, the television is used to show both the programs themselves as well as the EPG.

Typically, an EPG will be displayed in one of two ways. It will either be displayed using the full television screen, completely preempting the programming selection, or the EPG may occupy only a portion of the screen as an overlay, the rest of the screen used to display the current program. Where an EPG only occupies a portion of the screen, however, it may be difficult to read because of the small size of the text, or may not provide much information about the current selection or other programs. Additionally, the main program is interrupted by the overlay.

This method of displaying programming information can have several other disadvantages as well. When there are several viewers, if one decides to view the EPG, all other viewers must wait until the one using the EPG is finished. This interruption may be quite inconvenient for the other viewers.

Current interactive television systems, such as Wink™, WebTV™, or MSTV™ create interactive applications that a television viewer may use while they are watching television. Once the application becomes active, the interactive television system must alert the user that there is an interactive function available. Previous systems have either displayed a logo or a window on the television screen itself. This can be disruptive to all viewers as it interrupts the programming.

What is needed is a way to alert a user to the availability of interactive television without disrupting other viewers by displaying the alert on the screen itself.

### SUMMARY OF THE INVENTION

The present invention provides a method and apparatus for an interactive television system that can be controlled by voice through a remote control device. In one embodiment, a microphone is coupled with a remote control device. A user may speak into the microphone, and the remote control device sends the resulting data to a set top box (STB). The STB recognizes the voice commands and executes the users' command.

### BRIEF DESCRIPTION OF THE DRAWINGS

The present invention is illustrated by way of example and not limitation in the figures of the accompanying drawings, in which:

FIG. 1 illustrates an entertainment system with an electronic programming guide displayed on a remote computing device;

FIG. 2 illustrates an entertainment system with an electronic programming guide displayed on a wireless computing device;

FIG. 3 illustrates an entertainment system coupled with a number of wireless computing devices;

FIG. 4 illustrates a device for indicating that interactive services are available; and

FIG. 5 illustrates a device for controlling a set top box using voice commands.

### DETAILED DESCRIPTION

Applicants claim priority to provisional application serial No. 60/218098, filed Jul. 13, 2000, claims priority to provisional application serial No. 60/218022, filed Jul. 12, 2000, claims priority to provisional application serial No. 60/218015, filed Jul. 12, 2000, and claims priority to provisional application serial No. 60/215681, filed Jul. 30, 2000, which are incorporated herein by reference.

One embodiment provides a method and apparatus for controlling programming remotely using voice commands. In the following description, for purposes of explanation, specific details are set forth to provide a thorough understanding of the present invention. However, it will be apparent to one skilled in the art that these specific details are not required in order to practice the present invention.

An EPG allows a user to perform a range of functions that may be useful when watching television. Commonly assigned U.S. patent application Ser. No. 09/488,361, filed Jan. 16, 2000, describes in more detail the functions of an EPG and is hereby incorporated by reference.

The main function of an EPG is to allow a user to view program listings sorted by channel and time. Newer EPGs allow a user to browse through the listings, and to get detailed information about specific programs. EPGs may also allow a user to select certain channels or programs in which the user is particularly interested. Additionally, an EPG may control a recording device, and start recording when programs selected by the user are shown.

The typical television viewer now has many devices that have display screens, such as PCs, PDAs, web phones, etc., in addition to their television. Current EPGs are displayed on the television screen itself. This can lead to problems when there is more than one viewer, because viewers other than the one operating the EPG may not wish to view the EPG. Problems may also arise when the EPG attempts to display both the guide and a television program at the same time, because either the text may be too small or there may be too little information displayed. New display devices, such as PCs and PDAs give the user the opportunity to view the programming guide on an second screen, eliminating the problems associated with displaying an EPG and programs on the same screen.

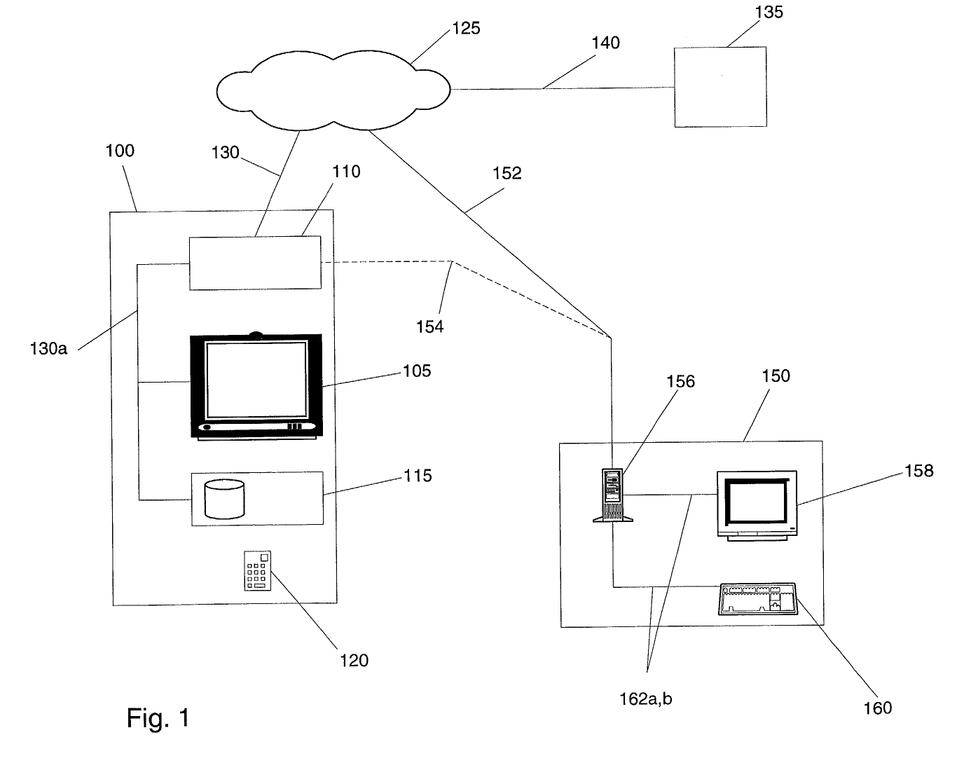

FIG. 1 illustrates an apparatus for displaying an EPG on a display other than the primary display according to one embodiment. Entertainment system 100 is an exemplary entertainment system which allows a user to watch television, record television programs, and perform various other functions.

As shown, entertainment system 100 includes a television or other video display 105, a set-top box (STB) 110, a digital or other recording device 115, and a remote control device 120.

Video display 105 can be a television, plasma screen, liquid crystal display (LCD) or any other device capable of interpreting and displaying signals sent by set top box 110 (STB). STB 110 is receives and descrambles cable television and other signals, allows for interaction with the viewer, and transmits the resulting signals to video display 105. Recording device 115 may be any one of or a combination of any one of a number of devices including video cassette recorders (VCRs), hard drives, digital versatile disc random access memory (DVD-RAM) recorders, etc. Video display 105, STB 110 and recording device 115 may also be combined in any fashion.

Set top box (STB) 110 can receive signals from network 125 through network connection 130. It can also receive information from link 130a to video display 105 and recording device 115. Remote control device 120 is capable of controlling the functions of the various components of entertainment system 100 using infrared or other transmission means.

Network 125 may consist of a single network or a group of networks such as the Internet. Network connection 130 can deliver signals to STB 110 over a local area network (LAN), a wide area network (WAN), satellite broadcast, or other data transmission means. Network connection 130 can deliver analog, digital or HDTV signals, or any combination thereof. Network connection 130 may also allow unidirectional or bi-directional Internet access.

In one embodiment, network 125 would comprise a single high-bandwidth digital network that allows both digital video streams and Internet access as well as other services to run on the same network. In another embodiment, the network connection 130 would comprise fiber optic cable, although it is clear that any means of connecting the network may be employed.

Although only a single network cloud 125 is shown in FIG. 1, in other embodiments, any number of different types information providers and network connections may be utilized. For example, broadcast server 135 has programs which can be viewed using entertainment system 100. Broadcast server 135 delivers information to network 125 through network link 140, and eventually to STB 110.

Computing device 150 is coupled with network 125 through network link 152. Computing device 150 may also be coupled with set top box 110 via network link 154. Because set top box 110 has its own network connection 130, it is also possible to forgo network connection 152 and route network access for computing device 150 through set top box 110.

Computing device 150 comprises a computer 156, a display screen 158, an input device 160, and connections 162a and 162b. Computer 156 may be any device, such as a Personal Computer (PC), a Personal Digital Assistant (PDA), or a web phone, capable of processing commands necessary to display output on display screen 158. Display screen 158 may be a computer monitor or an LCD screen, or any other device capable of displaying the output of computer 156.

Input device 160 may be a keyboard, mouse, joystick, writing tablet, or any other means of inputting data into computer 156. The components of computer 156 communicate with each other through connections 162a and 162b, although any number of additional connections may be added for additional peripherals and for additional connections between the already enumerated components.

As shown in FIG. 1, computing device 150 is simplified for purposes of explanation. Any number of additional components may be added to computing device 150 beyond those necessary for use with the invention.

As shown in FIG. 1, it is possible for several people to watch programming on video display 105 while one or more other persons uses computing device 150 to view an EPG on display screen 158. As a result, the programming displayed on video display 105 is undisturbed, and those perusing an EPG using computing device 150 can do so at their leisure. Also, because the EPG is shown on computing device 150, it is more easily customized and can be seen more clearly.

Input device 160 can be used to select programs to be watched on video display 105, or to otherwise browse through the EPG. In addition, a cable television provider sending programming to set top box 110 may have preset selections to send to computing device 150. A user may also use input device 160 to make viewing selections, preprogram reminders for viewing selections, program recording events, or perform any other function typical of Electronic Programming Guides (EPGs).

Recording device 115 can also be configured through the EPG to start recording slightly before a program is scheduled to begin and to end recording slightly after a program is scheduled to end in order to compensate for scheduling inaccuracies. A server, such as broadcast server 135 may also control these functions.

STB 110 may also provide for interactive functions such as online shopping, contests, games, chat, etc. Either input device 160 or remote control device 120 can be used to create input for the interactive functions of STB 110.

A user of the EPG displayed on computing device 105 may also, through input device 160, display portions of or the entire EPG on video display 105. This way, it is possible that a user may share programming information with all viewers, and thus the invention retains all of the benefits of previous EPGs displayed on a television. This also allows those who have poor vision, or are otherwise unable to use display screen 158, to use the EPG.

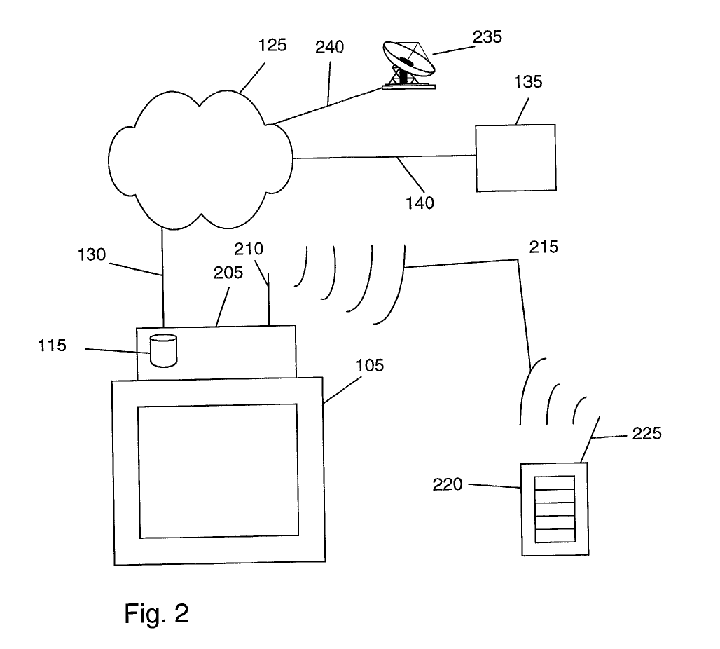

In another embodiment, an EPG could be displayed on a portable computing device. FIG. 2 illustrates an exemplary entertainment system with an EPG displayed on a wireless computing device.

Set top box (STB) 205 has an integrated antenna 210, which transmits RF waves 215. RF waves 215 can be received by hand held unit 220 through antenna 225. Hand held unit 220, could, for example, be a personal digital assistant (PDA). Hand held unit 220 could be equipped with a wireless interface such as Bluetooth™ to communicate with STB 205.

A wireless hand held device, such as hand held unit 220 allows for a great deal of flexibility. A user may move about the room which contains video display 105 and be able to control the functions of the EPG from any point. When using a wireless hand held device to control the EPG, the device may also assume the functions of remote control device 120.

FIG. 2 also shows a satellite receiver 235 connected with network 125 through network connection 240. Satellite receiver 235 can receive satellite signals, in addition to those already transmitted through the network from, e.g., broadcast server 135. Any one of a number of methods of transmitting signals to STB 205 may be employed.

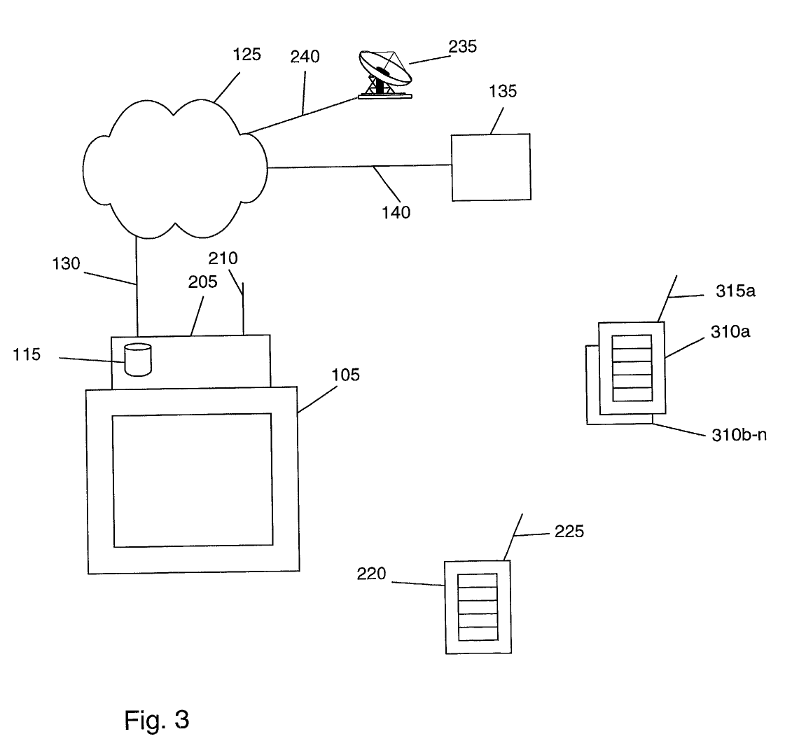

FIG. 3 illustrates an entertainment system coupled with a number of wireless hand-held devices. Similar to hand held unit 220, hand held units 310a-n can display an EPG for entertainment system 100 on their screens. However, hand-held units 10a-n are capable of communicating either with STB 205 through antennae 311a-n or with STB 205 through network 125. Hand held devices 310a-n may communicate with network 125 through any number of means, including but not limited to cellular, PCM, satellite, Blue-Tooth™, etc.

A television viewer may often wish to converse with others about which television program to watch. The suggested wireless connection allows all users to view the same EPG. Additionally, the connection may transmit each user's comments or changes to all other users. In one embodiment, because hand held devices 310a-n may connect with STB 205 through network 125, a user may program the EPG when they are away from home, and thus a number of users in a number of locations may view and program the same EPG.

After programming in their selections, and making changes to an EPG, a user's programming selections can be stored on the remote broadcast server 135, and can be downloaded through network 125 to a hand held unit 310a-n. A user can then control the functions of a set top box at a location other than home, such as a friend's house or a hotel. A user may make personalize his EPG, and recording device 115 can even continue to record programs while the user is away from home.

Recordings made by recording device 115 can be sourced out to a spindle farm, a DVD-RAM jukebox or any other massive storage medium. Recordings can be made and organized using the EPG provided to the STB 205. Such methods should be able to store massive amounts of data and a significant amount of video.

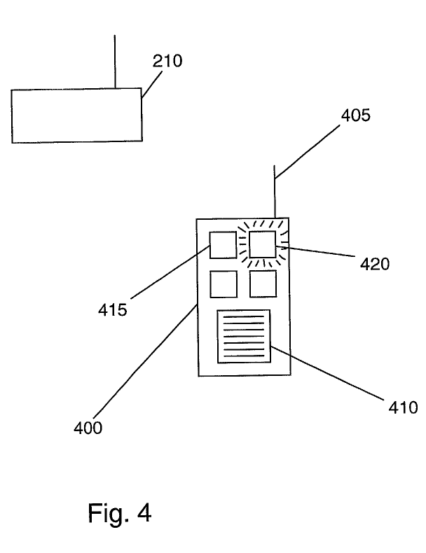

FIG. 4 illustrates a method and apparatus for indicating to a user that an interactive service is available. Remote control device 400 comprises antenna 405, display 410, and input-output (I/O) buttons 415.

Remote control device 400 uses antenna 405 to communicate with STB 210. Antenna 405 may be configured to communicate using radio-frequency (RF) waves, infrared waves, Bluetooth™, or any other means of wireless communication.

Display 410 may be used to alert a user of an interactive function. Display 410 may be, for example, a Liquid Crystal Display (LCD) with a colored backlight. When an interactive function begins, the backlight may either flash or change colors to alert the user to the possibility of interactive function. Further, display 410 may display several lines of text to inform the user of the nature of the interactive function. The user may then use buttons 415 to participate in the interactive function.

Additionally, or in lieu of display 410, one or more of buttons 415 may flash or change colors to alert a user of an interactive function. Button 420 is surrounded by a halo to signify that it is lit, and that an interactive function is available. It is also possible to incorporate some sort of audio tone or sound clip through a speaker (not shown) to act as a supplement or as a replacement for the methods described above.

When a provider wants to make an interactive application available, it sends a signal across network 125 to STB 210. STB 210 may then transmit the signal to remote control device 400 through antenna 405. When remote control device 400 receives the signal, it may alert the user as explained above.

Additionally, the alert to the interactive functions may be simultaneously sent to both the video display 105 and the remote control device 400. A user may configure the device such that they may either activate or deactivate the notice displayed on video display 105. Thus, the invention does not lose any of the functionality of previous methods of alerting a user of the possibility of an interactive function.

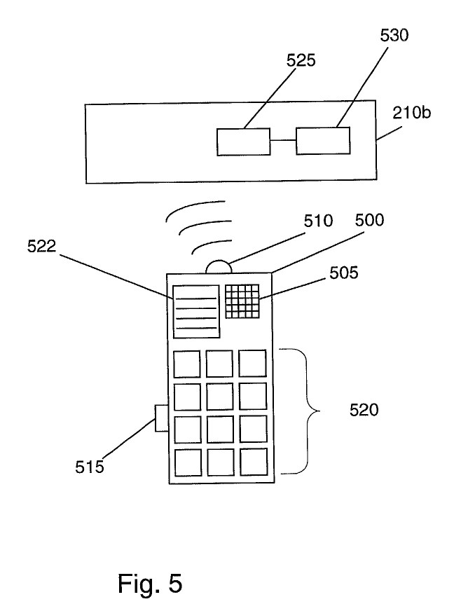

Set top box 210 may also be controlled by a remote control device capable of recognizing or recording voice commands. FIG. 5 illustrates such a system. Voice controlled remote control device 500 comprises a microphone 505, an infrared or other transmitter 510, a record button 515, a set of set of function buttons 520, and a display screen 522. Voice controlled remote control device 500 can control set top box 210b, which further contains an infrared or other receiving unit 525, and a central processing unit (CPU) 530.

A user may speak into microphone 505 in order to give commands to STB 210b. Microphone 505 may be designed so that a user may place the microphone close to their mouth to reduce the amount of background noise.

Once a user speaks into microphone 505, circuitry within voice controlled remote control device 500 digitizes the speech. The resulting signal is transmitted to STB 210b via transmitter 510. Transmitter 510 may communicate with STB 210b using any of a number of different communications means. Depending on the configuration of voice controlled remote control device 500, the digitized speech may be processed before being sent to STB 210b, or STB 210b may handle all or part of the processing chore.

A user may signal to voice controlled remote control device 500 that they are ready to begin speaking by pressing record button 515. Record button 515 may not necessarily have to be included in the invention, as circuitry which activates the recording feature of voice controlled remote control device 500 may be incorporated. Additionally, both the recording button and the voice controlled function may be included for the convenience of the user.

Voice controlled remote control device 500 also includes standard remote control buttons 520, which may be used to adjust the channel, volume, etc. Display screen 522 is similar to display 410 in FIG. 4. The functionality of remote control device 400 may also be incorporated into voice controlled remote control device 500. So, display screen 522 may be used to alert a user of an interactive function by changing color or blinking. In addition, the display screen 522 may display text transmitted to voice controlled remote control device 500 from STB 210b.

Once the signal leaves transmitter 510, it is then received by a corresponding receiver 525 on STB 210b. Receiver 525 sends the signal to CPU 530. It is understood that CPU 530 normally requires other components, such as memory and input/output devices, to process a signal received from receiver 530. These components are well known in the art and thus are not exemplified here.

When using certain transmission technologies, such as infrared, to transmit signals from voice controlled remote control device 500 to STB 210b, the transmission may lack the requisite speed to send an adequate sound sample. To remedy such a situation, voice controlled remote control device 500 may also include a circuit capable of storing several seconds of audio, such as those typically found in microchip voice recorders. The command may be stored on the chip, and later transmitted to STB 210b. When using other, faster transmission technologies, such as Bluetooth™, this may not be necessary.

Voice controlled remote control device 500 may also incorporate circuitry to recognize a specific user's voice print. A voice print is similar to a fingerprint. A user's voice is uniquely their own, and there are technologies known in the art that can recognize a user's unique voice print and identify a certain user. This may allow the STB to recognize a user and then recall their customized program settings. Voice prints could also be used for parental control, or to allow secure electronic commerce.

Voice commands may also be used to allow for easier electronic commerce. STB 210b may, for example, send a sales offer to voice controlled remote control device 500, which would subsequently alert the user by illuminating display screen 522 and displaying text concerning the offer on display screen 522. A user could then respond to the offer using the voice command feature of voice controlled remote control device 500. A user could pay for the purchase using either an on-file credit card, or by billing the purchase to their cable services bill.

For example, a restaurant could make an offer available to a service provider. The service provider could then send the offer to a user's STB 210b. The STB 210b sends a signal to voice controlled remote control device 500. The signal contains a message which is displayed on display screen 522. The message indicates to the user than an offer is being made. If the user chooses to accept the offer, the user may speak into microphone 505, when the user may both accept the offer and provide specific instructions to the restaurant. The user's instructions are digitized, sent to STB 210b, then sent back to the service provider, and finally the restaurant. The restaurant fills the user's order and delivers the order to the user. The user may then be billed to his cable account, an on-file credit card, or they may pay cash upon delivery.

The system and method described herein may be stored in the memory of a computer system (i.e., a set-top box) as a set of instructions to be executed. In addition, the instructions to perform the system and method described herein may alternatively be stored on other forms of machine-readable media, including magnetic and optical disks. For example, the system and method of the present invention may be stored on machine-readable media, such as magnetic disks or optical disks, which are accessible via a disk drive (or computer-readable medium drive). Further, the instructions may be downloaded into a computing device over a data network in the form of a compiled and linked version.

Alternatively, the logic to perform the system and method described herein may be implemented in additional computer and/or machine-readable media such as discrete hardware components as large-scale integrated circuits (LSI's), application specific integrated circuits (ASIC's), firmware such as electrically erasable programmable read-only memory (EEPROM's), and electrical, optical, acoustical, and other forms of propogated signals (e.g., carrier waves, infrared signals, digital signals, etc.).

The embodiments above have been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the embodiments as claimed. Accordingly, the scope is defined by the appended claims rather than the forgoing descriptions of embodiments.

1. An apparatus comprising:
An unit to transmit information and to receive information via wireless;
A voice activated control unit to interact with an electronic programming guide (EPG); and
An indicator to indicate an availability of an interactive function in a program corresponding to the EPG.

2. The apparatus of claim 1, wherein the voice activated control unit identifies a voice print of a speaker to grant operational access.

3. The apparatus of claim 1, wherein the apparatus includes a memory device to store verbal commands prior to transmitting the verbal commands.

4. The apparatus of claim 2, wherein the display changes background colors to indicate the availability of the interactive function in the program corresponding to the EPG.

5. The apparatus of claim 2, wherein the display flashes to indicate the availability of the interactive function in the program corresponding to the EPG.

6. The apparatus of claim 1, wherein the apparatus is personal digital assistant.

7. The apparatus of claim 1, wherein the apparatus is a web phone.

8. The apparatus of claim 1, wherein indicator is a unit that generates a sound to indicate the availability of the interactive function in the program corresponding to the EPG.

9. The apparatus of claim 1, wherein the indicator is a section of the apparatus that illuminates to indicate the availability of the interactive function in the program corresponding to the EPG.

10. A method comprising:
An apparatus transmitting information via wireless in response to voice activation commands, the information interacting with an electronic programming guide (EPG); and
The apparatus indicating an availability of an interactive function in a program corresponding to the EPG.

11. The method of claim 10, further including identifying a voice print of a speaker to grant operational access.

12. The method of claim 10, further including storing verbal commands prior to transmitting the verbal commands.

13. The method of claim 10, wherein the indicating includes is displaying an indicator on a display of the apparatus.

14. The method of claim 13, wherein the indicating includes changing the background colors of the display to indicate the availability of the interactive function in the program corresponding to the EPG.

15. The method of claim 13, wherein the indicating includes the display flashing to indicate the availability of the interactive function in the program corresponding to the EPG.

16. The method of claim 10, wherein the apparatus is personal digital assistant.

17. The method of claim 10, wherein the apparatus is a web phone.

18. The method of claim 10, wherein the indicating includes a unit of the apparatus generating a sound to indicate the availability of the interactive function in the program corresponding to the EPG.

19. The method of claim 10, wherein the indicating includes a section of the apparatus illuminating to indicate the availability of the interactive function in the program corresponding to the EPG.

20. A machine readable medium having stored thereon a set of instructions, which when executed cause a system to perform a method comprising:
An apparatus transmitting information via wireless in response to voice activation commands, the information interacting with an electronic programming guide (EPG); and
The apparatus indicating an availability of an interactive function in a program corresponding to the EPG.

21. The machine readable medium of claim 20 further including identifying a voice print of a speaker to grant operational access.

22. The machine readable medium of claim 20 further including storing verbal commands prior to transmitting the verbal commands.

23. The machine readable medium of claim 20, wherein the indicating includes is displaying an indicator on a display of the apparatus.

24. The machine readable medium of claim 23, wherein the indicating includes changing the background colors of the display to indicate the availability of the interactive function in the program corresponding to the EPG.

25. The machine readable medium of claim 23, wherein the indicating includes the display flashing to indicate the availability of the interactive function in the program corresponding to the EPG.

26. The machine readable medium of claim 20, wherein the apparatus is personal digital assistant.

27. The machine readable medium of claim 20, wherein the apparatus is a web phone.

28. The machine readable medium of claim 20, wherein the indicating includes a unit of the apparatus generating a sound to indicate the availability of the interactive function in the program corresponding to the EPG.

29. The machine readable medium of claim 20, wherein the indicating includes a section of the apparatus illuminating to indicate the availability of the interactive function in the program corresponding to the EPG.
